(19) United States
(12) Patent Application Publication
(10) Pub. No.: US 2012/0118679 A1
(43) Pub. Date: May 17, 2012

(54) DEVICE FOR GENERATING SHAFT DATA IN AN ELEVATOR INSTALLATION

(76) Inventor: Marco Aluisetti, Locarno (CH)

(21) Appl. No.: 13/297,686

(22) Filed: Nov. 16, 2011

(30) Foreign Application Priority Data
Nov. 16, 2010 (EP) 10191336.6

(51) Int. Cl. B66B 7/02; F16M 13/02

(52) U.S. Cl. 187/406; 248/205.1; 211/26

(57) ABSTRACT

A device for generating shaft data in an elevator installation includes an information transmitter and a mount. The mount has a first limb, a back and a second limb, the first limb has a first section and a second section and the second limb includes elements for receiving the information transmitter. The second section of the first limb lies, in a use state, substantially between the first section of the first limb and the second limb.

### CROSS-REFERENCE TO RELATED APPLICATION

This application claims priority to European Patent Application No. 10191336.6, filed Nov. 16, 2010, which is incorporated herein by reference.

### FIELD

The disclosure relates to a device for generating shaft data in an elevator installation.

### BACKGROUND

Magnets arranged in an elevator shaft serve, together with magnet switches arranged at an elevator cage, for generating shaft information. When the elevator cage moves in the elevator shaft the magnet switches the magnet switches, which are usually constructed as bistable magnet switches, from one switching state to another switching state. An instantaneous position of the elevator cage in the elevator shaft is thereby determined for an elevator control on the basis of the position of the relevant magnet. The magnets, which, for example, are arranged in the region of a story, are usually arranged at fastening means. In that case the magnets are displaceable along the guide rails.

EP 0 982 257 A2 discloses a shaft magnet device for generating shaft data in an elevator installation. A mount comprising a foot part, back part and front part is designed for reception of a magnet. The foot part and the front part of the mount are pressed against the guide rail by a spring characteristic of the back part so that the mount can be fastened to the guide rail. However, in some cases this mount has to be used for exactly one specific thickness of guide rail. Thus, this mount generally cannot be used for guide rails of different design. Moreover, a retaining force of the mount is limited.

### SUMMARY

At least some of the disclosed embodiments provide a device for generating shaft data in an elevator installation, which can be used at guide rails with different thicknesses. In addition, at least some embodiments are simple to produce and allow simple installation. Moreover, at least some embodiments provide a secure fixing with a sufficiently high holding force and are displaceable at a guide rail in simple mode and manner.

Particular embodiments of a device for generating shaft data in an elevator installation comprise an information transmitter and a mount, the mount having a first limb, a back and a second limb, wherein the first limb has a first section and a second section and wherein the second limb has elements for reception of the information transmitter. The second section of the first limb in a use state comes to lie substantially between the first section of the first limb and the second limb.

In an exemplifying embodiment the first limb has a bending section which lies between the first section and the second section so that the second section is connected with the first section to be bendable relative thereto. This can mean that the mount can be of integral construction. The bending section can accordingly be constructed from the same material as the first limb, the back and the second limb. Production can thereby be simplified and production costs can be kept low. In an alternative form of embodiment a joint is arranged between the first section of the first limb and the second section of the first limb.

In an exemplifying embodiment the information transmitter comprises a magnet. Magnets have the advantage that they are economic and form a robust switch together with a magnet switch. In addition, a magnet can increase the retention force of the device for generation of shaft data at a guide rail, because the magnet additionally adheres to the guide rail. In an alternative form of embodiment other information transmitters such as, for example, RFID chips can be used.

In a further exemplifying embodiment the device further comprises a spring which is arranged between the first section and the second section and the second section is thereby acted on by a force which urges the second section against the second limb. Through use of such a spring the retention force of the device at a guide rail is further increased.

In a further exemplifying embodiment the first section and the second section can have spring retaining elements which in a use situation of the device keep the spring in a predefined position in relation to the first section and the second section. Insertion of the spring into the mount is thereby simplified and the spring can be prevented from leaving its predefined position in the mount. In another exemplifying embodiment a spring constant of the spring lies in a range between 2 N/mm and 30 N/mm.

In a further exemplifying embodiment the second limb has a first arm and a second arm, wherein the first arm and the second arm are arranged substantially parallel to one another so that the information transmitter can be clamped in place between the first arm and the second arm.

In a further exemplifying embodiment the second section of the first limb can be pivoted through between the first arm and the second arm of the second limb. This can mean that dimensioning of the second section of the first limb is not confined to a spacing between the first and the second limbs but is limited substantially to a dimension of the first section of the first limb.

In a further exemplifying embodiment the second section comprises laterally arranged detent elements which prevent the second section from pivoting back out of a position substantially between the first section and the second limb into a position substantially in a prolongation of the first section. This can mean that the second section can, before mounting on a guide rail, already be brought into its use position between the first section and the second limb without pivoting back. The mount can thereby be readied in advance, which can allow simpler mounting.

In addition, thanks to these detent elements the spring can already be premounted between the first section and the second section of the first limb before the mount is mounted on a guide rail.

In a further exemplifying embodiment the mount is formed as an injection-molded part and/or consists of at least partly of polypropylene. This can mean that the mount can be produced economically and in simple mode and manner.

In a further exemplifying embodiment the device can be clamped against an object with the thickness between 2 millimeters and 10 millimeters.

In a further exemplifying embodiment the device comprises a third limb which has elements for reception of a second information transmitter. Through a second information transmitter, which is possibly arranged in a vertical path different from that of the first information transmitter, it is possible to define further functions. For example, the second information transmitter can be used as a signal for door opening.

In a further exemplifying embodiment the third limb and the second limb are arranged at substantially the same height at the back so that a first information transmitter arranged in the second limb and a second information transmitter arranged in the third limb are disposed substantially adjacent to one another, wherein the back lies substantially on a plane between the first information transmitter and the second information transmitter. It is thereby achieved that the first information transmitter and the second information transmitter in a use state are arranged in different vertical paths.

In at least some embodiments, the device is arranged at a mounting limb of a guide rail. In an exemplifying embodiment at least one device is arranged per story.

### BRIEF DESCRIPTION OF THE DRAWINGS

The disclosure is explained in more detail in the following on the basis of exemplifying embodiments illustrated in figures, in which:

FIG. 1A shows an exemplifying form of embodiment of a mount in side view;

FIG. 1B shows an exemplifying form of embodiment of a mount in rear view;

FIG. 1C shows an exemplifying form of embodiment of a mount in plan view;

FIG. 1D shows an exemplifying form of embodiment of a mount in perspective illustration;

FIG. 2 shows an exemplifying form of embodiment of a mount with inserted spring, in side view;

FIG. 3 shows an exemplifying form of embodiment of a mount with a third limb, in perspective illustration;

FIG. 4A shows an exemplifying form of embodiment of a device for generating shaft information at a guide rail, in side view; and

FIG. 4B shows an exemplifying form of embodiment of a device for generating shaft data at a guide rail, in perspective illustration.

### DETAILED DESCRIPTION

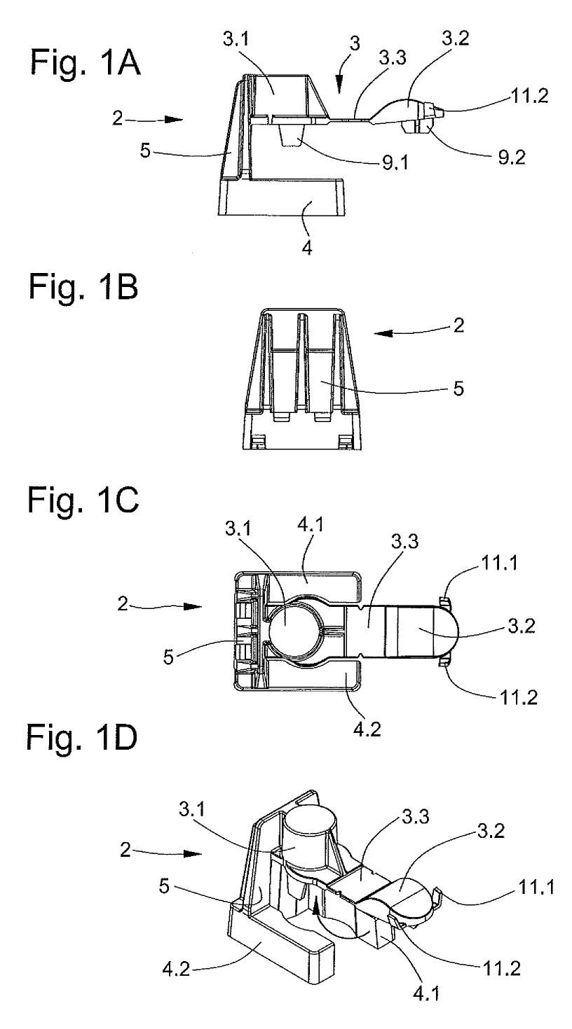

A mount 2 is illustrated from different viewing angles in FIGS. 1A to 1D. The mount 2 comprises a back 5, a first limb 3 and a second limb 4. The mount 2 can be in that case of integral construction.

The back 5 is connected not only with the first limb 3, but also with the second limb 4. On a side remote from the limbs 3, 4 the back 5 has longitudinally directed bracings. These bracings increase the stability of the back 5. By virtue of the increased stability the back 5 is in a position of accepting increased forces of the limbs 3, 4 without bending.

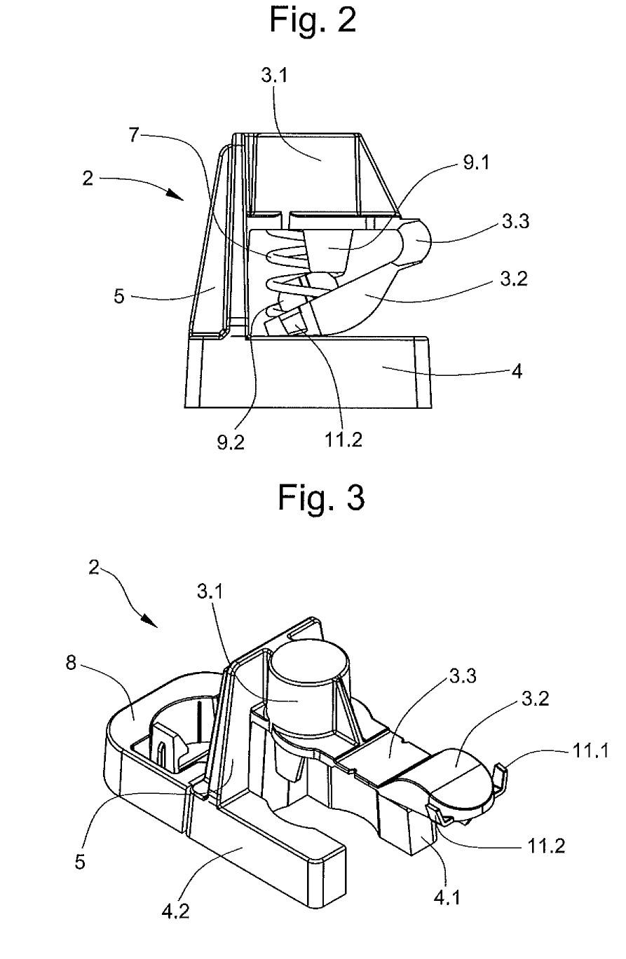

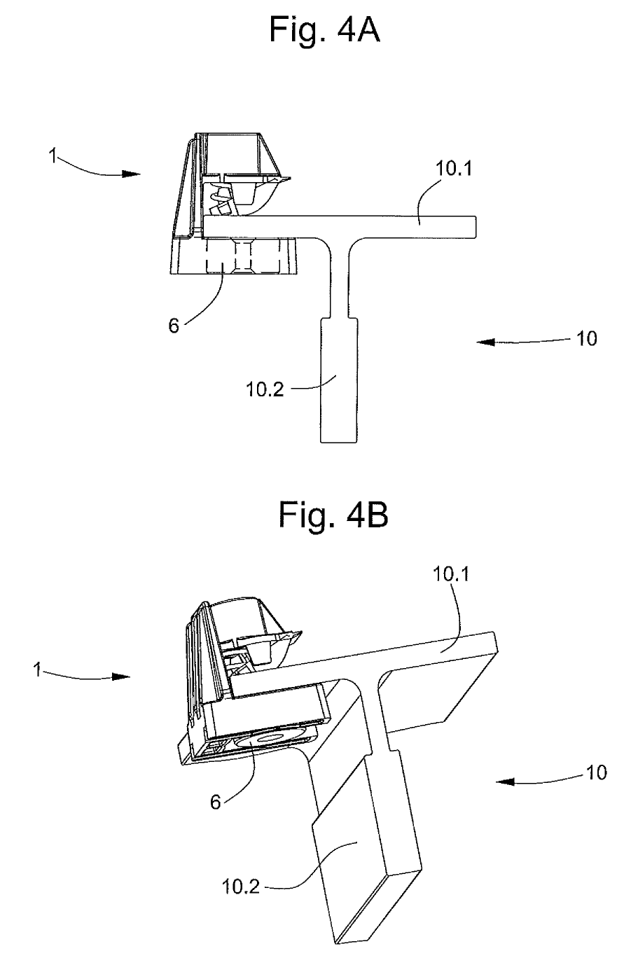

The first limb 3 has a first section 3.1 and a second section 3.2. Arranged between the first section 3.1 and the second section 3.2 is a bending section 3.3. The first section 3.1 can be, like the back 5, formed with bracings to be torsionally stiff. The second section 3.2 can be similarly formed to be torsionally stiff by virtue of its three-dimensional structure. The bending section 3.3 is constructed as a flat connecting member between the first section 3.1 and the second section 3.2. The second section 3.2 is thereby bendable upwardly and downwardly, but not laterally, about the bending section 3.3. In FIGS. 1A to 1D the first limb is in a state in which the mount 2 is produced. In a use state the first limb 3 is bent so that the second section 3.2 comes to lay between the first section 3.1 and the second section 4 (see for this purpose FIGS. 2, 4A and 4B). An arrow in FIG. 1D indicates in which direction the second section 3.2 of the first limb 3 can be bent in order to prepare the mount 2 for use.

The first limb 3 has spring retaining elements 9.1, 9.2 for the arrangement of a spring. In that case, a first spring retaining element 9.1 is arranged at the first section 3.1 and a second spring retaining element 9.2 is arranged at the second section 3.2.

In a use state the first spring retaining element 9.1 is arranged substantially opposite the second spring retaining element 9.2 so that a spring can be fixed by the spring retaining elements 9.1, 9.2.

The second limb 4 comprises a first arm 4.1 and a second arm 4.2. The first arm 4.1 and the second arm 4.2 in that case are arranged substantially parallel to one another. The first arm 4.1 and the second arm 4.2 are both connected with the back 5. An information transmitter is receivable between the first arm 4.1 and the second arm 4.2. The first arm 4.1 and the second arm 4.2 have inward bulges so that a circular information transmitter can be received by the arms 4.1, 4.2.

The first limb 3 and the second limb 4 are so dimensioned that the second section 3.2 of the first limb 3 is pivotable through between the arms 4.1, 4.2 of the second limb. This is apparent particularly from FIG. 1C. The second section 3.2 of the first limb 3 has detent elements 11.1, 11.2. These detent elements 11.1, 11.2 protrude laterally from the second section 3.2. It is thereby achieved that the second section 3.2 after pivoting through between the arms 4.1, 4.2 is prevented from pivoting back into the original position, such as is shown in FIGS. 1A to 1 D. As apparent from FIG. 1D, the detent elements 11.1, 11.2 are so designed that they can be folded in between the arms 4.1, 4.2 when the second section 3.2 is pivoted through, wherein they are not folded in between the arms 4.1, 4.2 in the case of opposite movement of the second section 3.2 and thereby prevent the second section 3.2 from pivoting back.

The mount 2 is formed as an injection-molded part. It consists at least partly of polypropylene.

A mount 2 with an inserted spring 7 is illustrated in FIG. 2. By contrast with the mount shown in FIGS. 1A to 1D the mount in FIG. 2 is illustrated in a use state. The second section 3.2 is bent about the bending section 3.3 and lies substantially between the first section 3.1 and the second limb 4. The detent elements 11.1, 11.2 prevent the second section 3.2 from pivoting back into its original position. The spring elements 9.1, 9.2 keep the spring 7 in its predefined position between the first section 3.1 and the second section 3.2. Not only the bending section 3.3, but also the spring 7 have the effect that the second section 3.2 is urged against the second limb 4. If now an object is pushed between the second section 3.2 and 30 the second limb 4, then the second section 3.2 is urged further towards the first section 3.1 and the spring 7 is further compressed. The second section 3.2 is thereby pressed against the pushed-in object so that the mount 2 is fixed to the pushed-in object.

A mount 2 with a third limb 8 is illustrated in FIG. 3. The third limb 8 is, like the 5 first limb 3 and the second limb 4, arranged at the back 5. In that case the third limb 8 and the second limb 4 are arranged at substantially the same height at the back 5. However, the third limb 8 is arranged at the back 5 in opposite direction with respect to the second limb 4. The third limb 8 has means for reception of an information transmitter. In that case, the second limb 4 and the third limb 8 are 10 constructed in such a manner that information transmitters inserted therein come to lie substantially adjacent to one another. If the mount 2 is clamped laterally against a vertical guide rail then the information transmitters received in the second limb 4 and the third limb 8 lie adjacent to one another and are disposed in respectively different vertical paths.

A device for generating shaft data in an elevator installation is illustrated in FIG. 4A. The device 1 comprises a mount 2 and an information transmitter 6 inserted therein. The information transmitter 6 is constructed as a cylindrical magnet. The device 1 is mounted on a guide rail 10. The guide rail 10 comprises a mounting 20 limb 10.1 and a guide limb 10.2. Guide shoes of an elevator cage (not illustrated) engage the guide limb 10.2. The device 1 is arranged at one of the mounting limbs 10.1 of the guide rail 10. In that case the information transmitter 6 is aligned in such a manner that it is oriented in the direction of the guide limb 10.2 and thus the elevator cage.

A device for generating shaft data is again arranged at a guide rail 10 in FIG. 48. It is apparent from this perspective illustration that the device 1 can, for example, be displaced upwardly and downwardly in simple mode and manner along the mounting limb 10.1 of the guide rail 10. The information transmitter 6 can thereby 30 be displaced to the intended height in the elevator installation.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator installation component comprising:
an information transmitter; and
a mount, the mount comprising a first limb, a back and a second limb, the first limb comprising a first section and a second section, the second limb comprising elements for receiving the information transmitter, the second section of the first limb being substantially positionable between the first section of the first limb and the second limb.

2. The elevator installation component of claim 1, the first limb comprising a bending section positioned between the first section and the second section, the second section being connected with the first section and bendable relative to the first section.

3. The elevator installation component of claim 1, the information transmitter comprising a magnet.

4. The elevator installation component of claim 1, further comprising a spring arranged between the first section and the second section, the spring urging the second section against the second limb.

5. The elevator installation component of claim 4, the first section and the second section comprising respective spring retaining elements, the respective spring retaining elements being configured to keep the spring in a predefined position relative to the first section and the second section.

6. The elevator installation component of claim 4, the spring having a spring constant between 2 N/mm and 30 N/mm.

7. The elevator installation component of claim 1, the second limb comprising a first arm and a second arm, the first and second arms being arranged substantially parallel to each other, the first and second arms being further arranged such that the information transmitter can be positioned between the first and second arms.

8. The elevator installation component of claim 7, the second section of the first limb being pivotable between the first and second arms of the second limb.

9. The elevator installation component of claim 8, the second section comprising laterally arranged detent elements, the laterally arranged detent elements being configured to maintain the second section substantially between the first section and the second limb.

10. The elevator installation component of claim 1, the mount being at least partially injection-molded.

11. The elevator installation component of claim 1, the mount being formed at least partly of polypropylene.

12. The elevator installation component of claim 1, the component being configured to be clamped to an object having a thickness between 2 mm and 10 mm.

13. The elevator installation component of claim 1, the information transmitter being a first information transmitter, the mount further comprising a third limb, the third limb comprising one or more elements for receiving a second information transmitter.

14. The elevator installation component of claim 13, the third limb and the second limb being positioned at substantially the same height at the back, the first information transmitter being coupled to the second limb and the second information transmitter being coupled to the third limb, the first information transmitter and the second information transmitter being arranged substantially adjacent to each other, the back being substantially in a plane between the first information transmitter and the second information transmitter.

15. An elevator installation, comprising:
a guide rail, the guide rail comprising a mounting limb; and
an elevator installation component, comprising,
an information transmitter, and
a mount coupled to the mounting limb, the mount comprising a first limb, a back and a second limb, the first limb comprising a first section and a second section, the second limb comprising elements for receiving the information transmitter, the second section of the first limb being substantially positionable between the first section of the first limb and the second limb.

16. The elevator installation of claim 15, the elevator installation component being one of a plurality of elevator installation components, the plurality of elevator installation components being arranged across a plurality of stories.
